(19) United States
(12) Patent Application Publication
(10) Pub. No.: US 2019/0281135 A1
(43) Pub. Date: Sep. 12, 2019

(54) Scheduling Delivery Of Information Centric Networking Content

(71) Applicant: Telefonaktiebolaget LM Ericsson (publ), Stockholm (SE)

(72) Inventors: Neiva Linder, Stockholm (SE); Kim Laraqui, Solna (SE); Ala Nazari, Handen (SE); Ioanna Pappa, Stockholm (SE)

(21) Appl. No.: 16/076,047

(22) PCT Filed: Feb. 19, 2016
(86) PCT No.: PCT/SE2016/050130

§ 371 Date: Aug. 7, 2018

(51) Int. Cl. H04L 29/08; H04W 4/50

(52) U.S. Cl. CPC H04L 67/327; H04L 67/16; H04W 4/50; H04L 67/322

(57) ABSTRACT

The invention relates to wireless communication device and a method performed at the wireless communication device of requesting Information Centric Networking (ICN) content, a network node, and a method performed at the network node of scheduling delivery of ICN content to at least one wireless communication device. In an aspect, a method performed at a network node(102) of scheduling delivery of ICN content to at least one wireless communication device (103) provided. The method comprises receiving (S101a) a request for the ICN content from the at least one wireless communication device (103), deriving (S102), from the received request, content description data specifying at least one property of the ICN content being requested, and scheduling (S103) delivery of the requested ICN content to the at least one wireless communication device (103) on the basis of the derived at least one property of the requested ICN content.

### TECHNICAL FIELD

The invention relates to wireless communication device and a method performed at the wireless communication device of requesting Information Centric Networking (ICN) content, a network node, and a method performed at the network node of scheduling delivery of ICN content to at least one wireless communication device.

The invention further relates to computer programs comprising computer-executable instructions for causing a wireless communication device and a network node to perform steps of the methods of the invention when the computer-executable instructions are executed on a respective processing unit included in the device and the network node, and to computer program products comprising computer readable mediums, the computer readable mediums having the computer programs embodied thereon.

### BACKGROUND

Over recent years, Information/Content Centric Networking (ICN/CCN) is gaining momentum as a future technology for 5th generation mobile networks (“5G”) and other coming technologies for media distribution, device software upgrades and the Internet of Things (IoT).

ICN/CCN may be utilized for delivery of content to a wireless communications device, commonly referred to as a User Equipment, over e.g. a 3rd Generation Partnership Project (3GPP) network, where the UE may be embodied in the form a smart phone, tablet, laptop, a gaming console, etc., or a so called fixed wireless terminal (FWT) in the form of e.g. a television set, a computer, or a set top box.

If ICN/CCN is implemented in a Radio Access Network (RAN) part of a system alongside e.g. a 3GPP core network, referred to as an Evolved Packet Core (EPC) network in case of implementation in a Long-Term Evolution (LTE) network, Radio Base Stations (RBSs) must be arranged to handle communication over the ICN and EPC concurrently.

As transfer of content over ICN/CCN increases, a greater burden will be placed on the RBSs to manage an ever increasing amount of data to be delivered to UEs via ICN/CCN. There is thus a need to improve a radio resource management mechanism of ICN content at the RBSs.

### SUMMARY An object of the present invention is to solve, or at least mitigate this problem in the art, and to thus improve radio resource management when delivering ICN content at a network node.

This object is attained in a first aspect of the invention by a method performed at a wireless communication device of requesting ICN content. The method comprises submitting a request for the ICN content to an network node, the request being configured to contain content description data specifying at least one property of the ICN content being requested, content description data is utilized by the network node to schedule delivery of the ICN content to the wireless communication device.

This object is attained in a second aspect of the invention by a wireless communication device configured to request ICN content, which wireless communication device comprises a processing unit and a memory, the memory containing instructions executable by the processing unit, whereby the wireless communication device is operative to submit a request for the ICN content to an network node, the request being configured to contain content description data specifying at least one property of the ICN content being requested, the data being utilized by the network node to schedule delivery of the ICN content to the wireless communication device.

This object is attained in a third aspect of the invention by a method performed at a network node of scheduling delivery of ICN content to at least one wireless communication device. The method comprises receiving a request for the ICN content from the at least one wireless communication device, deriving, from the received request, content description data specifying at least one property of the ICN content being requested, and scheduling delivery of the requested ICN content to the at least one wireless communication device on the basis of the derived at least one property of the requested ICN content.

This object is attained in a fourth aspect of the invention by a network node configured to schedule delivery of ICN content to at least one wireless communication device, which network node comprises a processing unit and a memory, the memory containing instructions executable by the processing unit, whereby the network node is operative to receive a request for the ICN content from the at least one wireless communication device, to derive, from the received request, content description data specifying at least one property of the ICN content being requested, and schedule delivery of the requested ICN content to the at least one wireless communication device on the basis of the derived at least one property of the requested ICN content.

Advantageously, by configuring the ICN content request of one or more wireless communication devices with the content description data specifying one or more properties of the ICN content being requested, the network node—being e.g. a radio an RBS or an Access Point such as a wireless router, home gateway, fixed wireless terminal, etc.—schedules subsequent delivery of the requested ICN content already at reception of the requests. Thus, the appropriate radio resources are pre-allocated by the network node before any ICN content is fetched upstream from the appropriate ICN node(s).

Hence, the ICN content property being embedded in the content description may for instance facilitate estimation of the expected traffic volume and QoS requirements for radio bearer establishment in order to support pre-scheduling at the network node; when requested ICN content packets arrive at the network node from the ICN node, the network node scheduler has already allocated resources and/or defined any order of priority for delivery of the ICN content to the wireless communication devices.

Thus, radio resource management is greatly improved at the network node, and the risk of traffic congestion at the network node upon receiving the requested ICN content is mitigated as compared to the prior art.

In a further embodiment, the network node is operative to submit a request for the ICN content to at least one ICN node, receiving the requested ICN content from the at least one ICN node, and delivering the received ICN content in accordance with the previously scheduled delivery of the requested ICN content of the wireless communication device(s).

In an embodiment of the invention, the at least one property specified by the content description data of the ICN request is being selected from a group comprising: type of ICN content, size of ICN content, resolution of ICN content, Quality of Service, QoS, with which the ICN content is to be delivered, priority with which the ICN content is to be delivered. In practice, any other property that can be used to improve the resource allocation operation of the network node can be envisaged

In yet a further embodiment, the request for ICN content from the at least one wireless communication device is configured to contain content description data specifying a plurality of properties of the ICN content being requested, at least two of the plurality of properties being utilized by the network node to schedule delivery of the ICN content to the wireless communication device. Advantageously, by using a number of properties, more information is taken into account, and more advanced scheduling can be accomplished.

In still a further embodiment, the data content description is included in a Type-Length-Value (TLV) element of the request for ICN content of e.g. a CCNx network protocol, or a Named Data Networking (NDN) network protocol.

The object is attained in a fifth aspect of the invention by computer programs comprising computer-executable instructions for causing a wireless communication device and a network node to perform steps of the methods of the invention when the computer-executable instructions are executed on a respective processing unit included in the device and the network node.

The object is attained in a sixth aspect of the invention by computer program products comprising computer readable mediums, the computer readable mediums having the computer programs of the fifth aspect embodied thereon.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 illustrates a general operating principle of prior art ICN/CCN content delivery;

FIG. 2 shows a schematic overview of an exemplifying wireless communication system in which the present invention can be implemented;

FIG. 3 shows a timing diagram illustrating an embodiment of the invention;

FIG. 4 shows a timing diagram being a continuation of that shown in FIG. 3, illustrating a further embodiment of the invention;

FIG. 5 illustrates a wireless communication device according to an embodiment of the invention; and

FIG. 6 illustrates a network node according to an embodiment of the invention.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

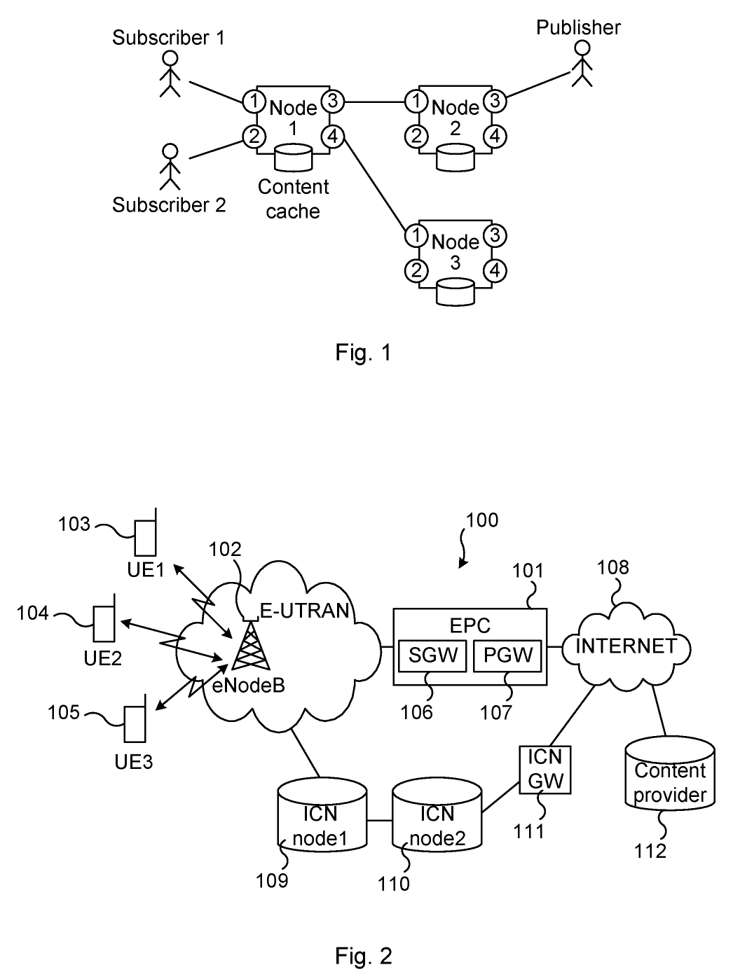

FIG. 1 illustrates a general operating principle of prior art ICN/CCN content request and delivery. This operating principle assumes that a link used in one direction—e.g. between Node 1 and Node 2 essentially being switches equipped with large caches for transporting content—to send content requests from subscribers is also used in the other direction to send the corresponding content back via Node 1 and Node 2 from a content provider to the subscribers. All links in ICN/CCN are therefore assumed to allow for bi-directional communication. A request in ICN terminology is commonly referred to as an “interest”.

Multicast support is a key feature in ICN/CCN when transporting a particular content from a content provider to various subscribers/end users whom have requested content from that particular content provider. Whenever a node which has received content requests from several subscribers over different interfaces (each node being illustrated to comprise four interfaces in FIG. 1) receives requested content available for delivery, the node will deliver the requested content to the subscribers over a respective interface.

With reference to FIG. 1, if both Subscriber 1 and 2 request the same content, e.g. a live video stream, both subscribers will submit a request/interest to Node 1. However, Node 1 will only forward a single request to Node 2 for that video stream, and Node 2 will as a result forward the single request towards the content provider. The content provider will thereafter return a single copy of the requested live stream to Node 2. Likewise, Node 2 will only send one copy of the live stream over its link to Node 1. Node 1 will then replicate the content of the video stream and send it to both Subscriber 1 and 2. As can be concluded ICN/CCN technology provides for an efficient, scalable and flexible approach of delivering information to an end-user.

Information Centric Networking and Content Centric Networking are sometimes also referred to as Named Data Networking (NDN). In the following, the term ICN will be used to encompass ICN, CCN and NDN technology.

In contrast to traditional Internet Protocols (IPs), ICN addresses content objects using names instead of IP addresses.

FIG. 2 shows a schematic overview of an exemplifying wireless communication system in which the present invention can be implemented.

The wireless communication system 100 is an LTE based system, where the packet core network 101 is referred as an Evolved Packet Core (EPC) network.

In the following, the network node according to an embodiment will be exemplified in the form of an RBS. However, any appropriate network node with ICN capability used for wireless communication terminal scheduling may be envisaged. Further, the invention may be implemented in other communication systems, such as a 5th generation (5G) wireless system.

The wireless communication system 100 comprises at least one base station 102 in the form of an eNodeB, which forms the LTE radio access network referred to as Evolved Universal Terrestrial Radio Access Network (E-UTRAN). In practice, a number of eNodeBs together form the E-UTRAN. The eNodeB is a radio access node that interfaces with one or more mobile radio terminals (UEs), in this schematic overview illustrated by a first UE 103, a second UE 104, and a third UE 105.

The eNodeB 102 is operatively connected to a Serving Gateway (SGW) 106 configured to route and forward user data packets, in turn operatively connected to an upstream Packet Data Network Gateway (PGW) 107, which provides connectivity from the UEs to external packet data networks 108, such as the Internet, by being the point of exit and entry of traffic for the UEs.

It should be noted that FIG. 2 is for illustrational purposes only, and that e.g. the EPC network 101 in practice is far more complex with a variety of functional nodes intercommunicating with each other.

Further illustrated in FIG. 2 are a first ICN node 109 and a second ICN node 110, the first ICN node 109 connecting downstream to the eNodeB 102 in the E-UTRAN and the second ICN node 110 connecting upstream to an ICN gateway in for access to the IP network 108. As previously mentioned, the ICN nodes are essentially switches equipped with large caches for storing much-requested content for rapid delivery upon request.

FIG. 2 functionally illustrates that the first ICN node 109 and the second ICN node 110 are separate from the eNodeB 102. However, one or more of the ICN nodes 109, 110 may even be arranged within eNodeB 102. In any case, the ICN path terminates locally at the eNodeB 102.

Hence, requests (a.k.a. “interests”) for popular content from UE1, UE2 and UE3 will be sent to the eNodeB 102, which in its turn will send an upstream request to the first ICN node 109 and if the requested content is not residing in its cache, the request will proceed upstream to the second ICN node 110, and so on, potentially all the way via the ICN GW in and the IP network 108 to a content provider 112 being the source of the content.

Once the content has been encountered at one of the nodes, for example at the second ICN node 110, the content will be delivered via the same bi-directional link in a downstream direction via the first ICN node 109 to the eNodeB 102, which in its turn transmits the requested content to a requesting UE or even broadcasts the requested content to a plurality of UEs requesting the same content, for instance in case a number of end-users is watching a live streaming sport event.

Thus, the structure of ICN advantageously allows for more rapid delivery of popular, much-requested content as compared to data request and delivery occurring over the core network 101. It should further be noted that even though content would be requested from a single one of the UEs, and thus not be considered a much-requested piece of content, the fetching and delivery of the requested content via ICN may still be advantageous as compared to fetching and delivering the requested content via e.g. a Content Data Network (CDN), which would require access via the EPC.

However, upon receiving the requested ICN content (or in practice a number of content objects) to be delivered to a large number of UEs, the eNodeB 102 will need to manage its radio resource and schedule the delivery of content objects to respective UE(s). For instance, a schedule of the eNodeB 102 may have to take into account amount of data to be delivered to a UE, type of content, Quality of Service (QoS) an end-user is entitled to.

As transfer of ICN content objects increases in a system such as the wireless communication system 100 illustrated in FIG. 2, a greater burden will be placed on the RBSs to manage an ever increasing amount of data to be delivered to UEs. This may further cause a bottleneck may arise at the eNodeB 102 upon reception of a large amount of content to be scheduled and delivered, possibly in concurrence with handling of user plane data and/or control plane data to/from the EPC 101.

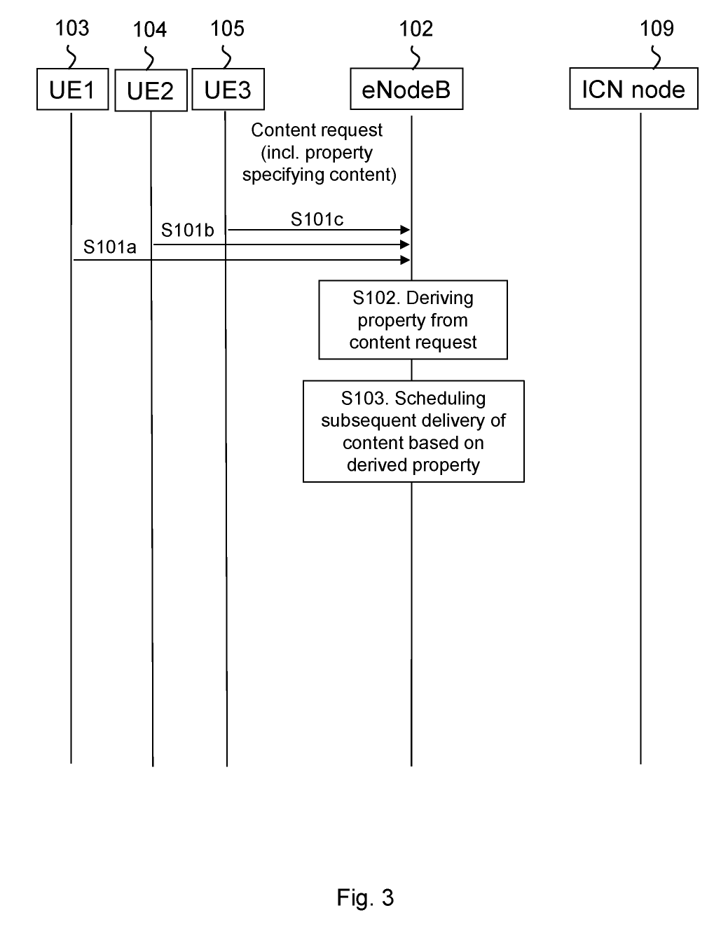

FIG. 3 shows a timing diagram illustrating an embodiment of the invention where ICN content initially is requested by three UEs 103, 104, 105, and thereafter scheduled by an eNodeB 102.

In a first step S101, all three UEs 103, 104. 105 submit a request for content to the eNodeB 102 (the requests are not necessarily received simultaneously at the eNodeB).

To this end, the UEs may be equipped with a client or an app in the form of e.g. a media player via which a user of the respective UE wishes to render a particular piece of content. The media player is ICN-compatible and thus generates a request (a.k.a. “interest”) for the content that the user wishes to render. Hence, the underlying ICN capability of the media player is typically not of concern to the user whom simply indicates in the media player a desired piece of content to be rendered. Thereafter, the media player submits the request addressing the content by means of its name rather than an IP address where the content can be found.

Streaming of content from the ICN nodes 109, 110 over the eNodeB 102 and on to the UEs 103, 104, 105 may be performed using Adaptive Bitrate Streaming utilizing a protocol such as Hypertext Transfer Protocol (HTTP) Live Streaming (HLS) or Moving Picture Experts Group Dynamic Adaptive Streaming over HTTP (MPEG-DASH).

Correspondingly, the media player is adapted to DASH and HLS and is equipped with an ICN access module for performing ICN functionality.

Now, when the media player requests a content object, e.g., video on YouTube, the file type, size, resolution and other parameters are usually known. For prior art MPEG-DASH type video downloading, which is the currently dominating solution, the media player of the UE will make an active choice of which next video stream (i.e. content object) to download from the ICN nodes via HTTP requests. This means that the media player is aware of certain properties of the ICN content to be requested.

In this embodiment, the request for ICN content generated by the media player is configured at the respective UE to contain content description data specifying at least one property of the ICN content being requested. The content description data may for instance be included in a so call Type-Length-Value (TLV) element of the prior art CCNx/NDN network protocol commonly used in ICN. Hence, the request may comprise a field in the form of a TLV element accommodating the content description data.

The property of the requested ICN content may be embodied in the form of e.g. content type (audio, video, image, text, live streaming, etc.), content size, content resolution, QoS with which the requested content is to be delivered, etc.

Upon receiving the request, the eNodeB 102 derives in step S102, from the content description data of the respective request, the property specifying the ICN content being requested.

Thereafter, in step S103, the eNodeB 102 pre-allocates resources to be used subsequently for delivering the request content. That is, based on the derived property of the ICN content, the eNodeB 102 schedules a subsequent delivery of the requested content to the respective UE.

In a simple example shown in Table 1 in the below, different content properties and scheduling decisions taken are briefly illustrated.

TABLE 1
Content property vs. scheduling decision.

| | | eNodeB scheduling |
|---|---|---|
| Device | Content Property | decision |
| UE1 | “Image” | Low bandwidth |
| UE2 | “Video” | High bandwidth |
| UE3 | “Audio” | Medium bandwidth |

With reference to the example of Table 1:
the first UE 103 indicates in its request in step S101a in the content description data that the requested content is an image,
the second UE 104 indicates in its request in step S101b in the content description data that the requested content is a video, while
the third UE 105 indicates in its request in step S101c in the content description data that the requested content is audio.

As described, these properties of the requested ICN content are derived by the eNodeB 102 in step S102 from the content description data of the respective request.

Thereafter, in step S103, the eNodeB 102 pre-allocates resources to be used subsequently for delivering the request content. That is, based on the derived property of the ICN content, the eNodeB 102 schedules a subsequent delivery of the requested content to the respective UE.

With reference to Table 1, the first UE 103 will be allocated a low bandwidth channel, the second UE 104 will be allocated a high bandwidth channel, while the third UE 105 will be allocated a medium bandwidth channel, over which the respective content subsequently will be delivered.

Advantageously, by configuring the ICN content request with the content description data specifying one or more properties of the ICN content being requested at the respective UE 103, 104, 105, the eNodeB 102 schedules subsequent delivery of the requested ICN content already at reception of the requests. Thus, the appropriate radio resources are pre-allocated by the eNodeB before any ICN content is fetched upstream from the appropriate ICN node(s) 109, 110.

Hence, the ICN content property being embedded in the content description may for instance facilitate estimation of the expected traffic volume and QoS requirements for radio bearer establishment in order to support pre-scheduling at the eNodeB 102; when requested ICN content packets arrive at the eNodeB 102 from the ICN node 109, the eNodeB scheduler has already allocated resources and/or defined any order of priority for delivery of the ICN content to the UEs 103, 104, 105.

Thus, radio resource management is greatly improved at the eNodeB 102, and the risk of traffic congestion at the eNodeB 102 upon receiving the requested ICN content is mitigated.

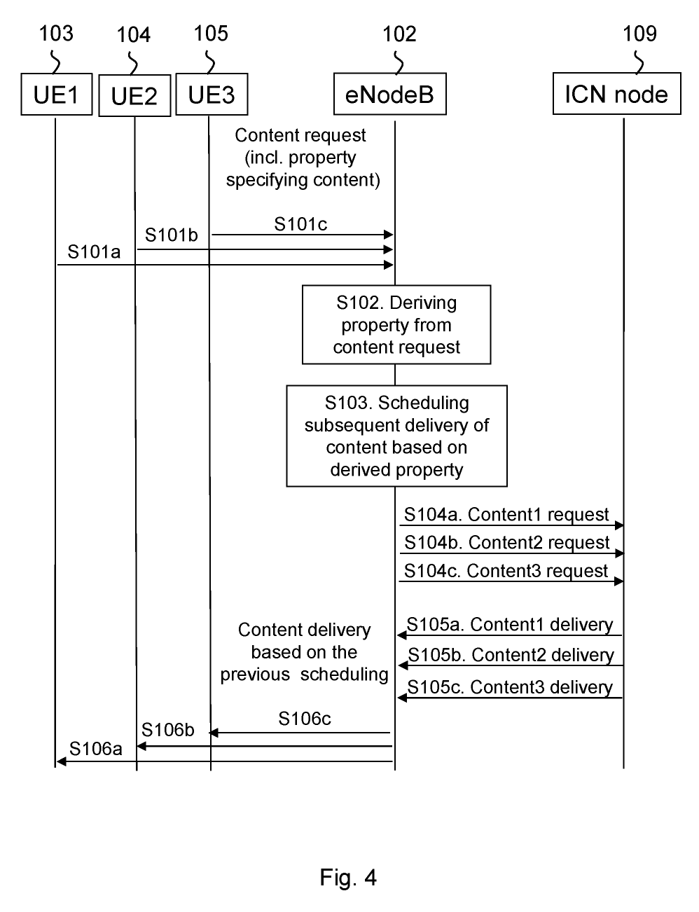

FIG. 4 shows a timing diagram being a continuation of that shown in FIG. 3, illustrating a further embodiment of the invention.

Hence, after the eNodeB 102 has received the respective ICN content request in steps S101c, derived the property specifying the requested ICN content from the content description data (in this particular example “image”, “video” and “audio”, respectively), and scheduled subsequent delivery of the requested ICN content, the eNodeB 102 submits requests in steps S104a, S104b and S104c for the content to the upstream ICN node 109. It should be noted that than an advantage of the ICN approach is that in case two or more UEs request the same content, for instance in case a live sport streaming event is rendered at the respective UE, the eNodeB 102 sends a single request to the ICN node 109, even though the requested content subsequently is to be delivered to hundreds or even thousands of end-users.

The ICN node 109 replies by delivering the requested content objects to the eNodeB 102 in steps S105a, S105b and S105c. Again, when the eNodeB 102 receives multiple requests for the same ICN content, the ICN node 109 will deliver that content to the eNodeB 102 for delivery to the UEs (possibly via broadcast).

It is envisaged that the action of broadcasting content is a scheduling decision that the eNodeB 102 may take on the basis of the property specifying requested content. For instance, if a great number of requests are made for the same content, i.e. the content description data of the request simply contains an identifier of the particular requested ICN content, the eNodeB 102 may pre-allocate a broadcast channel via which the requested ICN content subsequently will be delivered, upon arrival from the ICN node 109.

Hence, after the eNodeB 102 has received the requested ICN content from the ICN node 109 in steps S105a-c, the ICN content will advantageously be delivered to the UEs 103, 104, 105 in accordance with the previously performed scheduling in step S103.

In line with the example of Table 1, the eNodeB 102 will submit the requested image to the first UE 103 over a channel providing a lower bandwidth in step S106a, the requested video to the second UE 104 over a high-bandwidth channel in step S106b, and the requested audio to the third UE 105 over a channel with a medium bandwidth in step S106c.

The UEs can thus render the content received in the respective step S106a, S106b and S106c.

In still a further embodiment, a number of properties specifying the ICN content is included in the content description data submit with the request for the ICN content. For instance with reference to the example of Table 1; if not only content type but also e.g. the QoS the end-user is entitled to is included in the request, the scheduling decision taken by the RBS 102 may be different.

Assuming that the end-user of the second UE 104 has used up all her mobile data (typically consumed on a monthly basis), she may not be entitled to be assigned a high-bandwidth channel, but will be allocated a channel having a lower bandwidth.

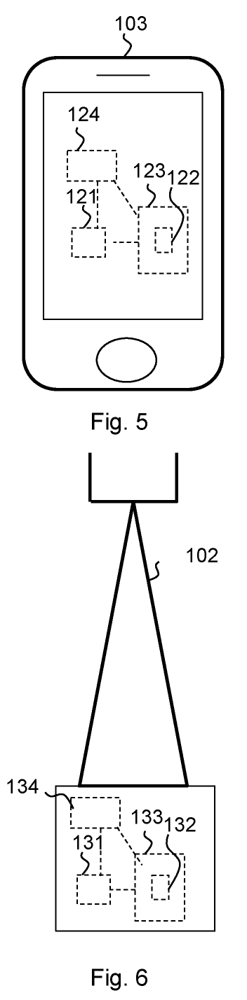

FIG. 5 illustrates a UE 103 according to an embodiment of the invention, while FIG. 6 illustrates an RBS 102 according to an embodiment of the invention.

As has been mentioned, the UE 103 comprises a client, such as a media player 124, for rendering ICN content received from the RBS 102. When the UE 103 requests ICN content in response to a user operating the media player 124 via e.g. a touch screen of the UE 103, thereby generating an ICN content request, the ICN request is typically created by a processing unit 121 of the UE 103, possibly in cooperation with the media player 124.

The steps of the method performed by the UE 103 according to embodiments of the invention are in practice performed by the processing unit 121 embodied in the form of one or more microprocessors arranged to execute a computer program 122 downloaded to the storage medium 123 associated with the microprocessor, such as a Random Access Memory (RAM), a Flash memory or a hard disk drive. The storage 123 is not necessarily shared with the media player 124, but the media player 124 may have its own cache from where it acquires ICN content.

The processing unit 121 is arranged to cause the UE 103 to carry out the method according to embodiments of the present invention when the appropriate computer program 122 comprising computer-executable instructions is downloaded to the storage medium 123 and executed by the processing unit 121. The storage medium 123 may also be a computer program product comprising the computer program 122. Alternatively, the computer program 122 may be transferred to the storage medium 123 by means of a suitable computer program product, such as a Digital Versatile Disc (DVD) or a memory stick. As a further alternative, the computer program 122 may be downloaded to the storage medium 123 over a network. The processing unit 121 may alternatively be embodied in the form of a digital signal processor (DSP), an application specific integrated circuit (ASIC), a field-programmable gate array (FPGA), a complex programmable logic device (CPLD), etc.

The steps of the method performed by RBS 102 of FIG. 6b according to embodiments of the invention are similarly in practice performed by a processing unit 131 embodied in the form of one or more microprocessors arranged to execute a computer program 132 downloaded to the storage medium 133 associated with the microprocessor, such as a Random Access Memory (RAM), a Flash memory or a hard disk drive. The processing unit 131 is arranged to cause the RBS 102 to carry out the method according to embodiments of the present invention when the appropriate computer program 132 comprising computer-executable instructions is downloaded to the storage medium 133 and executed by the processing unit 131. The storage medium 133 may also be a computer program product comprising the computer program 132. Alternatively, the computer program 132 may be transferred to the storage medium 133 by means of a suitable computer program product, such as a Digital Versatile Disc (DVD) or a memory stick. As a further alternative, the computer program 132 may be downloaded to the storage medium 133 over a network. The processing unit 121 may alternatively be embodied in the form of a digital signal processor (DSP), an application specific integrated circuit (ASIC), a field-programmable gate array (FPGA), a complex programmable logic device (CPLD), etc.

The processing unit 131 of the RBS 102 may perform the scheduling of radio resources for serving the UEs 103, 104, 105 with requested ICN content, or the scheduling may be performed by a separate scheduler 134 (or the processing unit 1321 and the scheduler together performs the scheduling).

As previously mentioned, streaming of content from the ICN nodes 109, 110 over the RBS 102 and on to the UEs 103, 104, 105 may be performed using Adaptive Bitrate Streaming utilizing a protocol such as HLS or MPEG-DASH.

Correspondingly, the media player 124 and scheduler 134 are adapted to DASH and HLS and is equipped with an ICN access module for performing ICN functionality.

The invention has mainly been described above with reference to a few embodiments. However, as is readily appreciated by a person skilled in the art, other embodiments than the ones disclosed above are equally possible within the scope of the invention, as defined by the appended patent claims.

1-16. (canceled)

17. A method, performed at a wireless communication device, of requesting Information Centric Networking (ICN) content, the method comprising the wireless communication device:
submitting a request for the ICN content to a network node, the request comprising content description data specifying at least one property of the ICN content being requested, the data being utilized by the network node to schedule delivery of the ICN content to the wireless communication device.

18. The method of claim 17, wherein the at least one property is selected from a group consisting of: type of ICN content, size of ICN content, resolution of ICN content, Quality of Service (QoS) with which the ICN content is to be delivered, and priority with which the ICN content is to be delivered.

19. The method of claim 17, wherein the request for ICN content comprises content description data specifying a plurality of properties of the ICN content being requested, at least two of the plurality of properties being utilized by the network node to schedule delivery of the ICN content to the wireless communication device.

20. The method of claim 17, wherein the content description data is included in a Type-Length-Value (TLV) element of the request for ICN content.

21. A method performed at a network node, of scheduling delivery of Information Centric Networking (ICN) content to at least one wireless communication device, the method comprising the network node:
receiving a request for the ICN content from the at least one wireless communication device;
deriving, from the received request, content description data specifying at least one property of the ICN content being requested; and
scheduling delivery of the requested ICN content to the at least one wireless communication device based on the derived at least one property of the requested ICN content.

22. The method of claim 21, further comprising:
submitting a request for the ICN content to at least one ICN node;
receiving the requested ICN content from the at least one ICN node; and
delivering the received ICN content in accordance with the scheduled delivery of the requested ICN content to the at least one wireless communication device.

23. The method of claim 21, wherein the at least one property is selected from a group consisting of: type of ICN content, size of ICN content, resolution of ICN content, Quality of Service (QoS) with which the ICN content is to be delivered, and priority with which the ICN content is to be delivered.

24. The method of claim 21, wherein the request for ICN content comprises content description data specifying a plurality of properties of the ICN content being requested, at least two of the plurality of properties being utilized by the network node to schedule delivery of the ICN content to the wireless communication device.

25. The method of claim 21, wherein the content description data is included in a Type-Length-Value (TLV) element of the request for ICN content.

26. A wireless communication device configured to request Information Centric Networking (ICN) content, the wireless communication device comprising:
processing circuitry;
memory containing instructions executable by the processing circuitry whereby the wireless communication device is operative to:
submit a request for the ICN content to a network node, the request comprising content description data specifying at least one property of the ICN content being requested, the data being utilized by the network node to schedule delivery of the ICN content to the wireless communication device.

27. The wireless communication device of claim 26, wherein the instructions are such that the wireless communication device is operative to include the content description data in a Type-Length-Value (TLV) element of the request for ICN content.

28. A network node configured to schedule delivery of Information Centric Networking (ICN) content to at least one wireless communication device, the network node comprising:
processing circuitry;
memory containing instructions executable by the processing circuitry whereby the network node is operative to:
receive a request for the ICN content from the at least one wireless communication device;
derive, from the received request, content description data specifying at least one property of the ICN content being requested; and
schedule delivery of the requested ICN content to the at least one wireless communication device based on the derived at least one property of the requested ICN content.

29. The network node of claim 28, wherein the instructions are such that the network node is operative to:
submit a request for the ICN content to at least one ICN node;
receive the requested ICN content from the at least one ICN node; and
deliver the received ICN content in accordance with the scheduled delivery of the requested ICN content to the at least one wireless communication device.

30. The network node of claim 28, wherein the at least one property is selected from a group consisting of: type of ICN content, size of ICN content, resolution of ICN content, Quality of Service (QoS) with which the ICN content is to be delivered, and priority with which the ICN content is to be delivered.

31. The network node of claim 28:
wherein the request for ICN content from the at least one wireless communication device contains content description data specifying a plurality of properties of the ICN content being requested; and
wherein the instructions are such that the network node is operative to utilize at least two of the plurality of properties to schedule delivery of the ICN content to the wireless communication device.

32. A non-transitory computer readable recording medium storing a computer program product for controlling a wireless communication device for requesting Information Centric Networking (ICN) content, the computer program product comprising software instructions which, when run on processing circuitry of the wireless communication device, causes the wireless communication device to:
submit a request for the ICN content to a network node, the request comprising content description data specifying at least one property of the ICN content being requested, the data being utilized by the network node to schedule delivery of the ICN content to the wireless communication device.

33. A non-transitory computer readable recording medium storing a computer program product for controlling a network node for scheduling delivery of Information Centric Networking (ICN) content to at least one wireless communication device, the computer program product comprising software instructions which, when run on processing circuitry of the network node, causes the network node to:
receive a request for the ICN content from the at least one wireless communication device;
derive, from the received request, content description data specifying at least one property of the ICN content being requested; and
schedule delivery of the requested ICN content to the at least one wireless communication device based on the derived at least one property of the requested ICN content.
